(19) United States
(12) Patent Application Publication
(10) Pub. No.: US 2006/0113875 A1
(43) Pub. Date: Jun. 1, 2006

(54) Piezoelectric vibrator, method of manufacturing the same, oscillator, electronic apparatus, and wave clock

(76) Inventor: Kishiro Nakamura, Chiba-shi (JP)

Correspondence Address: ADAMS & WILKS, 17 BATTERY PLACE, SUITE 1231, NEW YORK, NY, 10004, US

(21) Appl. No.: 11/286,373

(22) Filed: Nov. 23, 2005

(30) Foreign Application Priority Data
Nov. 26, 2004 (JP) 2004-341728
Aug. 12, 2005 (JP) 2005-234340

(51) Int. Cl. H04R 17/00

(52) U.S. Cl. 310/340; 29/25.35

(57) ABSTRACT

Provided is a method of manufacturing a piezoelectric vibrator including: forming integrally a vibrator piece and a frame surrounding the vibrator piece on a first wafer and forming bonding films on the both surfaces of the frame; forming a through-hole at a position corresponding to the frame of the first wafer in any one of a second wafer and a third wafer; sticking the second wafer and the third wafer on the both surfaces of the first wafer, respectively; and cutting the stuck wafers at a predetermined position. Here, the forming of the vibrator piece and the frame includes forming a non-bonding film area smaller than the through-hole at a position corresponding to the through-hole of the bonding film, and the cutting of the wafers includes cutting the wafers such that the non-bonding film area is divided.

### BACKGROUND OF THE INVENTION

1. Field of the Invention

The present invention relates to a piezoelectric vibrator, a method of manufacturing the same, and an oscillator, an electronic apparatus and a wave clock including the piezoelectric vibrator.

2. Description of the Related Art

Recently, a piezoelectric vibrator having a small size and high reliability is required for electronic apparatuses such as portable telephones, portable personal digital assistants, AV apparatuses, OA apparatuses, and in-vehicle apparatuses. A vibrator in which a piezoelectric vibrator piece is stuck to a ceramic base using an adhesive has a problem that the vibrator piece is peeled off to stop oscillation upon a drop impact test. As an example of means for solving this problem, there are provided a surface mount type piezoelectric vibrator which has a frame integrally connected to one end of a vibrator piece and including bonding films at the both surfaces thereof, and is composed by bonding the frame, a lid and a base, and a method of manufacturing the same.

An example of the piezoelectric vibrator will now be described with reference to the accompanying drawings. FIG. 9 is an exploded perspective view illustrating an example of a surface mount type piezoelectric vibrator. In FIG. 9, the piezoelectric vibrator has a frame 2 which is connected to one end of a vibrator piece 1 and is integrally formed to surround the vibrator piece. Bonding films (not shown) are formed on the both surfaces of the frame 2. On the front surface of the frame 2, a lid 7 having a first concave portion 9 is bonded at a portion facing the vibrator piece 1 through the bonding film. Beveling portions 7a are formed at four edges of the non-bonding surface of the lid 7. On the rear surface of the frame 2 at the opposite side of the lid 7, a base 8 having a second concave portion 10 is bonded at a portion facing the vibrator piece 1 through the bonding film. In the base 8, external connecting portions 13 in which external electrode films (not shown) are formed are provided at four corners thereof. In addition, beveling portions (not shown) are formed at four edges of the non-bonding surface of the base 8, similar to the lid 7.

A method of manufacturing the surface mount type piezoelectric vibrator having the aforementioned construction will be schematically described with reference to flowcharts illustrated in FIGS. 10 and 11.

A piezoelectric wafer which is a first wafer and is made by cutting a rude ore of quartz crystal is polished to a predetermined thickness and cleaned (step 10). Thereafter, a plurality of vibrator pieces 1 including an exciting electrode film are formed in the wafer by a chemical process such as etching, and a bonding film made of a metal thin film such as aluminum alloy is formed on the both surfaces of the frame 2 which is integrally connected to one end of the vibrator piece 1 and surrounds the vibrator piece 1 (step 11).

A second wafer (hereinafter, referred to as a lid wafer 5) is polished to a predetermined thickness and cleaned, and an uppermost affected layer thereof is removed by etching (step 20). Next, a plurality of first concave portions 9 are formed in the bonding surface such that mechanical deformation due to vibration of the vibrator is not prevented from being generated (step 21).

A third wafer (hereinafter, referred to as a base wafer 6) is polished to a predetermined thickness and cleaned, and an uppermost affected layer thereof is removed by etching, similar to the lid wafer 5 (step 30). Subsequently, a plurality of second concave portions 10 are formed in the bonding surface such that mechanical deformation due to vibration of the vibrator is not prevented from being generated (step 31). In addition, through-holes 11 which penetrate through the non-bonding surface and the bonding surface and in which an external electrode will be formed are formed in the base wafer 6 (step 32).

Three wafers prepared as described above are aligned at predetermined positions in accordance with reference marks provided on the respective wafers in an alignment process (step 40). The piezoelectric wafer 4 is interposed between the lid wafer 5 and the base wafer 6. Subsequently, overlapped three wafers are stuck to one another by an anodic boding device (step 41).

Subsequently, grooves each having a V-shaped section are formed in the non-bonding surface of the base wafer 6 by a dicing saw or the like, with a position and an interval (pitch of the long side direction is P1 and pitch of the short side direction is P2 (see FIG. 13)) corresponding to a predetermined size of the individual piezoelectric vibrator (step 42). Here, a process of forming the V-shaped grooves is referred to as bevel cut. The term V-shaped groove includes an inverted trapezoidal groove. Next, a metal thin film is formed on the through-holes 11 and a predetermined area of the base wafer and thus the external electrode is formed therein (step 43).

A subsequent cut process (step 44) will be described with reference to the flowchart illustrated in FIG. 11. A dicing tape is stuck on the non-bonding surface of the base wafer 6 (step 441) and the wafer is mounted on a work table such that the base wafer faces the work table (step 442). Subsequently, bevel cut is performed in the non-bonding surface of the lid wafer 5 with the same pitches P1 and P2 at a position facing the V-shaped grooves formed in the base wafer 6 to form V-shaped grooves therein (step 443). Subsequently, the wafer is divided into individual piezoelectric vibrators with the pitch P1 of the long side direction and the pitch P2 of the short side direction (step 444). Here, the process of individually cutting and dividing the plurality of piezoelectric vibrators formed in the wafer is referred to as full-cut. The divided piezoelectric vibrators are irradiated with ultraviolet rays to be separated from the dicing tape (step 445).

The manufacturing method will now be described with reference to the flowchart illustrated in FIG. 10 again. The divided piezoelectric vibrators are individually frequency-trimmed (step 45). Since the ends of the bonding films are exposed to the four side surfaces except the front surface of the lid and the lower surface of the base of each piezoelectric vibrator, a corrosion resist film is coated on the five surfaces including the upper surface of the lid except the lower surface of the base on which the external terminal is formed (step 46).

In order to confirm performance in environment resistance test of the piezoelectric vibrator manufactured as described above, the piezoelectric vibrator was subjected to a pressure cooker test and constant temperature and humidity tests 1 and 2 and a resonance resistance value and an oscillation frequency of the piezoelectric vibrator are measured over time. The prescribed test conditions of the pressure cooker test have a temperature of 121° C., a humidity of 100% and a test duration of 24 hours. The prescribed test conditions of the constant temperature and humidity test 1 have a humidity of 95%, a test duration of 1000 hours, and a temperature of 60° C. The prescribed test conditions of the constant temperature and humidity test 2 have a temperature of 85° C., a humidity of 85%, and a test duration of 1000 hours. The constant temperature and humidity test 2 is the most severe test.

TABLE 1
Failure occurrence rate in environment resistance test of the piezoelectric
vibrator according to a conventional manufacturing method

| | Test name | | |
|---|---|---|---|
| | Pressure cooker | Constant temperature | Constant temperature |
| | Test | and humidity test 1 | and humidity test 2 |
| | Temperature and humidity | | |
| | Temperature: 121° C. | Temperature: 60° C. | Temperature: 85° C. |
| | Humidity: 100% | Humidity: 95% | Humidity: 85% |
| | Test duration | | |
| Lot | 24 hours | 2000 hours | 2000 hours |
| Lot 1 (n = 30) | 0% | 0% | 6.7% |
| Lot 2 (n = 30) | 0% | 0% | 3.3% |

Table 1 illustrates failure occurrence rates in the respective tests as test results of samples (successive two lots) of the piezoelectric vibrator according to the aforementioned manufacturing method. In the actual test, the test duration of the pressure cooker test was set to 24 hours in accordance with the prescribed condition, but the test duration of the constant temperature and humidity-tests 1 and 2 was set to 2000 hours by adding 1000 hours to the prescribed time. The samples manufactured by the aforementioned manufacturing method have the failure occurrence rate of 0% in the pressure cooker test and the constant temperature and humidity test 1. However, in the constant temperature and humidity test 2, two failures (failure occurrence rate: 6.7%) occurs in lot 1 and one failure (failure occurrence rate: 3.3%) occurs in lot 2. As the result of microscopic observation of the sample failure, it is confirmed that the bonding film was corroded. The failure is caused by the frequency variation due to generation of leakage by the corrosion of the bonding film and increase of the resonance resistance value by deterioration of hermetic sealing (degradation of degree of vacuum).

The cause of the corrosion of the bonding film which occurs during 2000 hours in the particularly severe constant temperature and humidity test 2 will be analyzed as follows.

First, the cut process (full-cut) of the step 44 in the aforementioned manufacturing method will be described with reference to FIG. 12. As shown in FIG. 12, the lid wafer 5 is anodic-bonded to the upper surface of the piezoelectric wafer 4 through a first bonding film 3a. Similarly, the base wafer 6 having the through-holes 11 on which the external electrode films 12 are laminated is anodic-bonded to the lower surface of the piezoelectric wafer 4 through a second bonding film 3b. The full-cut is performed using a dicing saw (also referred to as dicer). At this time, a dicing tape 30 is stuck on the lower surface of the wafer which is a processed work). The wafer on which the dicing tape 30 is stuck is carried in an arrow direction 25 by a work table (not shown) and cut by a full-cut dicing blade 21 which rotates in an arrow direction 24.

In other words, the work to be cut is made of three wafers which are integralized by anodic bonding, not a single uniform material such as a silicon wafer. In addition, the layers of the work are arranged in the descending order of the lid wafer 5, the first bonding film 3a, the piezoelectric wafer 4, the second bonding film 3b, and the base wafer 6. The typical materials of the layers are arranged in the descending order of, for example, soda-lime glass, aluminum alloy, quartz crystal, aluminum alloy, and soda-lime glass. That is, the layers are composed of a combination of three kinds of materials. The materials of the layers except the bonding film have brittleness. Accordingly, the cut surfaces of the layers may be chipped or cracked or the bonding film may be peeled off by deterioration of the dicing blade 21 over time and wobbling in rotation of the blade. In a case where the first bonding film 3a and the second bonding film 3b are made of aluminum and aluminum alloy, respectively, even when a corrosion resist film is formed on the surface which is mechanically damaged and from which the film is peeled, it is considered that the surface is relatively weaker and thus is apt to be more corroded compared with the other place, in a long-term severe environment. Accordingly, minor leakage is generated and thus the hermetic sealing is gradually broken. Thus, the resonance resistance value or the oscillation frequency of the piezoelectric vibrator varies.

Particularly, a fact that there is a height probability of generating the aforementioned problems in the vicinity of four corners of the piezoelectric vibrator in which the full-cut of a long side direction and the full-cut of a short side direction intersect will be described with reference to the accompanying drawings. FIG. 13 is a view illustrating a portion of the bonded wafer when viewed at the base wafer having the through-hole. One piezoelectric vibrator has quarter areas of the through-hole at the four corners. A circle 17 is an opening of the end of the non-bonding surface of the through-hole and an inner circle 16 is formed in a taper shape and represents a circle of the end of the bonding surface having a diameter smaller than that of the opening.

Furthermore, in FIG. 13, cut lines 18 and 19 for dividing the piezoelectric vibrators with a predetermined size in the long side direction and the short side direction are shown. The intersection between the cut lines corresponds to the center of the circle 16 of the bottom of the through-hole. The full-cut area is denoted by a shadow area 22. The pitch of the long side direction is P1 and the pitch of the short side direction is P2. The layer structures of the vicinities of the four corners are rapidly changed due to existence of the through-hole. Furthermore, in the vicinity of the four corners, an affected layer generated by a first cut process may be chipped or cracked, or the film thereof is peeled off by a second cut process.

### SUMMARY OF THE INVENTION

Accordingly, an object of the prevent invention is to provide a piezoelectric vibrator which suppresses variation of characteristics such as a resonance resistance value and an oscillation frequency even in a severe environment, a method of manufacturing the piezoelectric vibrator, and an oscillator and an electronic apparatus including the piezoelectric vibrator.

According to a first aspect of the invention, there is a method of manufacturing a piezoelectric vibrator including: forming integrally a vibrator piece and a frame surrounding the vibrator piece on a first wafer and forming bonding films on the both surfaces of the frame; forming a through-hole at a position corresponding to the frame of the first wafer in any one of a second wafer and a third wafer; sticking the second wafer and the third wafer on the both surfaces of the first wafer, respectively; and cutting the stuck wafers at a predetermined position, wherein the forming of the vibrator piece and the frame includes forming a non-bonding film area smaller than the through-hole at a position corresponding to the through-hole of the bonding film, and the cutting of the wafers includes cutting the wafers such that the non-bonding film area is divided. The through-hole may be formed in any one of the second wafer and the third wafer.

It is preferable that, when forming the non-bonding film area, the center of the non-bonding film area is approximately placed in the vicinity of the intersection between a cut line of a long side direction and a cut line of a short side direction, which divide the piezoelectric vibrator, and the shape of the non-bonding film area is approximately symmetrical with respect to each of the two cut lines intersected.

Furthermore, it is preferable that, when forming the non-bonding film area, the shape of the non-bonding film area is composed of a combination of two rectangles and the centers of the two rectangles are identical to each other such that the respective long sides thereof form an angle of about 90 degrees.

In addition, it is preferable that, when forming the non-bonding film area, the sizes of the long sides of the two rectangles are smaller than the diameter of the bottom of the through-hole and the sizes of the short sides of the two rectangles are larger than the thickness of a cutting tool used in the cutting of the wafers.

Moreover, it is preferable that, when forming the non-bonding film area, the sizes of the long sides of the two rectangles are smaller than about 400 μm and the sizes of the short sides of the two rectangles are larger than about 150 μm.

According to a second aspect of the invention, there is provided a method of manufacturing a piezoelectric vibrator including: forming integrally a vibrator piece and a frame surrounding the vibrator piece on a first wafer and forming bonding films on the both surfaces of the frame; forming a through-hole at a position corresponding to the frame of the first wafer in any one of a second wafer and a third wafer; sticking the second wafer and the third wafer on the both surfaces of the first wafer, respectively; and cutting the stuck wafers at a predetermined position, wherein the cutting of the wafers includes cutting the wafers such that a shearing force of a cutting tool for cutting the wafers is applied from the wafer in which the through-hole is formed to the wafer in which the through-hole is not formed.

According to a third aspect of the invention, there is provided a method of manufacturing a piezoelectric vibrator including: forming integrally a vibrator piece and a frame surrounding the vibrator piece on a first wafer and forming bonding films on the both surfaces of the frame; forming a through-hole at a position corresponding to the frame of the first wafer in any one of a second wafer and a third wafer; sticking the second wafer and the third wafer on the both surfaces of the first wafer, respectively; and cutting the stuck wafers at a predetermined position, wherein the forming of the vibrator piece and the frame includes forming a non-bonding film area smaller than the through-hole at a position corresponding to the through-hole of the bonding film, and the cutting of the wafers includes cutting the wafers such that the non-bonding film area is divided and a shearing force of a cutting tool for cutting the wafers is applied from the wafer in which the through-hole is formed to the wafer in which the through-hole is not formed.

According to a fourth aspect of the invention, there is provided a piezoelectric vibrator manufactured by the method of manufacturing the piezoelectric vibrator. In more detail, the piezoelectric vibrator includes a vibrator piece; a frame which is connected to one end of the vibrator piece and integrally formed to surround the vibrator piece; a lid which is stuck to the frame through a first bonding film and has a concave portion at a position facing the vibrator piece; and a base which is stuck to the frame through a second bonding film at the opposite to the lid and has a concave portion at a position facing the vibrator piece and in which an external electrode is provided at the corner thereof, wherein a non-bonding film area is formed at a portion which contacts the external electrode of the second bonding film.

According to a fifth aspect of the invention, there is provided an oscillator in which the piezoelectric vibrator manufactured as described above is connected as an oscillator to an integrated circuit, wherein the piezoelectric vibrator includes: a vibrator piece; a frame which is connected to one end of the vibrator piece and integrally formed to surround the vibrator piece; a lid which is stuck to the frame through a first bonding film and has a concave portion at a position facing the vibrator piece; and a base which is stuck to the frame through a second bonding film at the opposite side of the lid and has a concave portion at a position facing the vibrator piece and in which an external electrode is provided at the corner thereof, wherein a non-bonding film area is formed at a portion which contacts the external electrode of the second bonding film.

According to a sixth aspect of the invention, there is provided an electronic apparatus in which the piezoelectric vibrator manufactured as described above is connected to a timing unit, wherein the piezoelectric vibrator includes: a vibrator piece; a frame which is connected to one end of the vibrator piece and integrally formed to surround the vibrator piece; a lid which is stuck to the frame through a first bonding film and has a concave portion at a position facing the vibrator piece; and a base which is stuck to the frame through a second bonding film at the opposite to the lid and has a concave portion at a position facing the vibrator piece and in which an external electrode is provided at the corner thereof, wherein a non-bonding film area is formed at a portion which contacts the external electrode of the second bonding film.

According to a seventh aspect of the invention, there is provided a wave clock in which the piezoelectric vibrator manufactured as described above is connected to a filter unit, wherein the piezoelectric vibrator includes: a vibrator piece; a frame which is connected to one end of the vibrator piece and integrally formed to surround the vibrator piece; a lid which is stuck to the frame through a first bonding film and has a concave portion at a position facing the vibrator piece; and a base which is stuck to the frame through a second bonding film at the opposite side of the lid and has a concave portion at a position facing the vibrator piece and in which an external electrode is provided at the corner thereof, wherein a non-bonding film area is formed at a portion which contacts the external electrode of the second bonding film.

A method of manufacturing a piezoelectric vibrator according to the invention includes forming on a first wafer integrally a vibrator piece and a frame which is connected to one end of the vibrator piece and surrounds the vibrator piece and forming bonding films for anodic bonding on the both surfaces of the frame; forming a through-hole for an external electrode in any one of a second wafer having a bonding surface and a non-bonding surface and a third wafer a bonding surface and a non-bonding surface; forming a non-bonding film area smaller than the end of the bonding surface of the through-hole at a portion of the bonding film of the first wafer aligned with the end of the bonding surface of the through-hole, and cutting the wafers such that the non-bonding film area is divided after the anodic bonding. By this construction, since the non-bonding film areas are placed at four corners of the piezoelectric vibrator in which a cut line of a long side direction and a cut line of a short side direction intersect while ensuring a sufficient contact area between the bonding film in the circle of the end of the bonding surface of the through-hole and a lamination film which is formed on the bonding film, is made of chromium and gold and forms a portion of the external electrode film, the bonding film is prevented from being peeled. Accordingly, the corrosion of the bonding film can be significantly reduced in a severe environment and thus a piezoelectric vibrator having excellent environment resistance performance can be provided.

Furthermore, in the method of manufacturing the piezoelectric vibrator according to the invention, the wafers are cut and divided into respective vibrators such that a shearing force of a cutting tool for the three wafers is applied from the wafer in which the through-hole is formed to the wafer in which the through-hole is not formed, the rotation direction of a blade becomes a direction of suppressing peeling of the bonding film and thus peeling of the bonding film placed in the through-hole can be reduced. Accordingly, the corrosion of the bonding film can be significantly reduced in a severe environment and thus a piezoelectric vibrator having excellent environment resistance performance can be provided.

Moreover, by employing both the method of forming the non-bonding film area in a portion of the bonding film and the method of cutting the wafers such that a shearing force in full-cut of the three wafers is applied from the wafer in which the through-hole is formed to the wafer in which the through-hole is not formed, it is possible to provide a piezoelectric vibrator having more excellent environment resistance performance. Further, in the piezoelectric vibrator manufactured by this manufacturing method, it is possible to sufficiently suppress variation of a resonance frequency or a resonance resistance value in a severe environment and thus maintain excellent environment resistance performance for a long time.

In addition, in the invention, since the center of the non-bonding film area is set to the vicinity of the intersection between the cut line of the long side direction and the cut line of the short side direction, it is identical to the center of the through-hole. Also, since the outer shape of the non-bonding film area is approximately symmetrical with respect to the two cut lines, even in three vibrators adjacent to the non-bonding film area, the non-bonding film areas are symmetrical and have the same area. Thus, it is possible to dispose an area having small variation between the vibrators.

Furthermore, in the invention, the shape of the non-bonding film area is composed of a combination of two rectangles, that is, a cross shape. By equalizing the centers of the two rectangles, the long sides of the rectangles form an angle of about 90 degrees. By this construction, it is possible to dispose the non-bonding film area in a simple shape. Thus, it is possible to easily design the shape of a mask and measure the sizes in monitoring of a process.

Moreover, in the invention, since the sizes of the long sides of the two rectangles are set to be smaller than the diameter of the through-hole, the non-bonding film area is not disposed at the outside of the circle of the bottom of the through-hole. Further, since the sizes of the short sides of the two rectangles are set to be larger than the thickness of the cutting tool for full-cut used after the anodic bonding, machining allowance for the thickness of the cutting tool occurs. Thus, it is possible to surely dispose the non-bonding film area.

In addition, in the invention, the sizes of the long sides of the two rectangles are smaller than about 400 μm and the sizes of the short sides of the two rectangles are larger than about 150 μm. The outer shape of the piezoelectric vibrator after full-cutting, has the size of the long side 3.2 mm or less, and the size of the short side 1.2 mm or less. Accordingly, it is possible to provide a tuning fork type piezoelectric vibrator having a small size and excellent environment resistance performance.

Furthermore, in the piezoelectric vibrator manufactured by the method of manufacturing the piezoelectric vibrator according to the invention, the bonding film is disposed in a area retreated from a front end inward in four corners, not in the cut surface. Accordingly, it is difficult that the cut surface is damaged due to chipping or wobbling in rotation of a dicing blade. Thus, it is possible to significantly reduce variation of a resonance frequency or a resonance resistance value of the vibrator even in a severe environment.

Moreover, in the invention, since the piezoelectric vibrator manufactured by the manufacturing method is connected to an integrated circuit of an oscillator, even when the oscillator is used in a severe environment having a high temperature and high humidity for a long time, it is difficult to vary the characteristics of the piezoelectric vibrator and thus the oscillator can be maintained with high precision.

In addition, in the invention, since the piezoelectric vibrator manufactured by the manufacturing method is connected to a timing unit of an electronic apparatus including a portable telephone, even when the electronic apparatus is used in a severe environment for a long time, it is difficult to vary the characteristics of the piezoelectric vibrator and thus the electronic apparatus can be used for a long time, while maintaining the performance.

In addition, in the invention, since the piezoelectric vibrator manufactured by the manufacturing method is connected to a filter unit of a wave clock, even when the wave clock is used even in a severe environment for a longtime, it is difficult to vary the characteristics of the piezoelectric vibrator and thus the electronic apparatus can be used for a long time, while maintaining the performance.

### BRIEF DESCRIPTION OF THE DRAWINGS

FIG. 1 is a flowchart illustrating in detail a process of forming a vibrator piece and a frame in a method of manufacturing a piezoelectric vibrator according to the invention, where FIG. 1A illustrates a typical example (first embodiment) and FIG. 1B illustrates an example (second embodiment) in which a bonding film has improved bonding characteristics;

FIG. 2 illustrates a non-bonding film area in a portion of the bonding film formed in the method of manufacturing the piezoelectric vibrator according to the invention, where FIG. 2A illustrates a relationship between the non-bonding film area and the bonding film area at the end of the bonding surface of a through-hole, FIG. 2B illustrates a relationship between the non-bonding film area and cut areas in full-cut, and FIG. 2C to 2E illustrate the other shapes of the non-bonding film area;

FIG. 3 is a flowchart illustrating in detail a cut process in the method of manufacturing the piezoelectric vibrator according to the invention;

FIG. 4 illustrates in the method of manufacturing the piezoelectric vibrator according to the invention, where FIG. 4A illustrates the overlap of three wafers, and FIG. 4B illustrates the cut process;

FIG. 5 illustrates an example of the piezoelectric vibrator according to the invention, where FIG. 5A is a plan view thereof, FIG. 5B is a front view illustrating AA′ cross section, FIG. 5C is a bottom view, and FIG. 5D is a partial enlarged view of an external connecting portion;

FIG. 6 is a schematic view illustrating a construction of a tuning fork type quartz crystal oscillator according to a third embodiment of the invention;

FIG. 7 is a schematic block diagram of an electronic apparatus according to a fourth embodiment of the invention;

FIG. 8 is a schematic circuit block diagram of a wave clock according to a fifth embodiment of the invention;

FIG. 9 is an exploded perspective view illustrating an example of a surface mount type piezoelectric vibrator;

FIG. 10 is a basic flowchart illustrating a method of manufacturing the surface mount type piezoelectric vibrator;

FIG. 11 illustrates in detail a conventional cut process in the method of manufacturing the surface mount type piezoelectric vibrator;

FIG. 12 illustrates the cut process performed in a conventional method of manufacturing a piezoelectric vibrator; and

FIG. 13 illustrates a portion of a wafer bonded in the conventional method of manufacturing the piezoelectric vibrator when viewed at a base having a through-hole.

### DESCRIPTION OF THE PREFERRED EMBODIMENTS

Hereinafter, a piezoelectric vibrator and a method of manufacturing the same according to embodiments of the invention will be described with reference to the accompanying drawings. It should be understood that, in the present embodiment, although a first wafer is made of a quartz crystal, and lid and base wafers, which are second and third wafers, respectively, are made of soda-lime glass, materials other than quartz crystal and glass may be used. Moreover, although a sample test result in which the thickness of the quartz crystal wafer is about 130 μm and the thickness of the glass wafer is about 400 μm is described, the thicknesses of the elements are not limited to these. Further, in the size (before coating the corrosion resist film) of the piezoelectric vibrator of the sample used in the environment resistance test, the length of the long side of the piezoelectric vibrator is 3.2 mm and the length of the short side thereof is 1.2 mm. If the size of the piezoelectric vibrator becomes smaller by miniaturization, the diameter of a through-hole or the size of a non-bonding film area are also reduced.

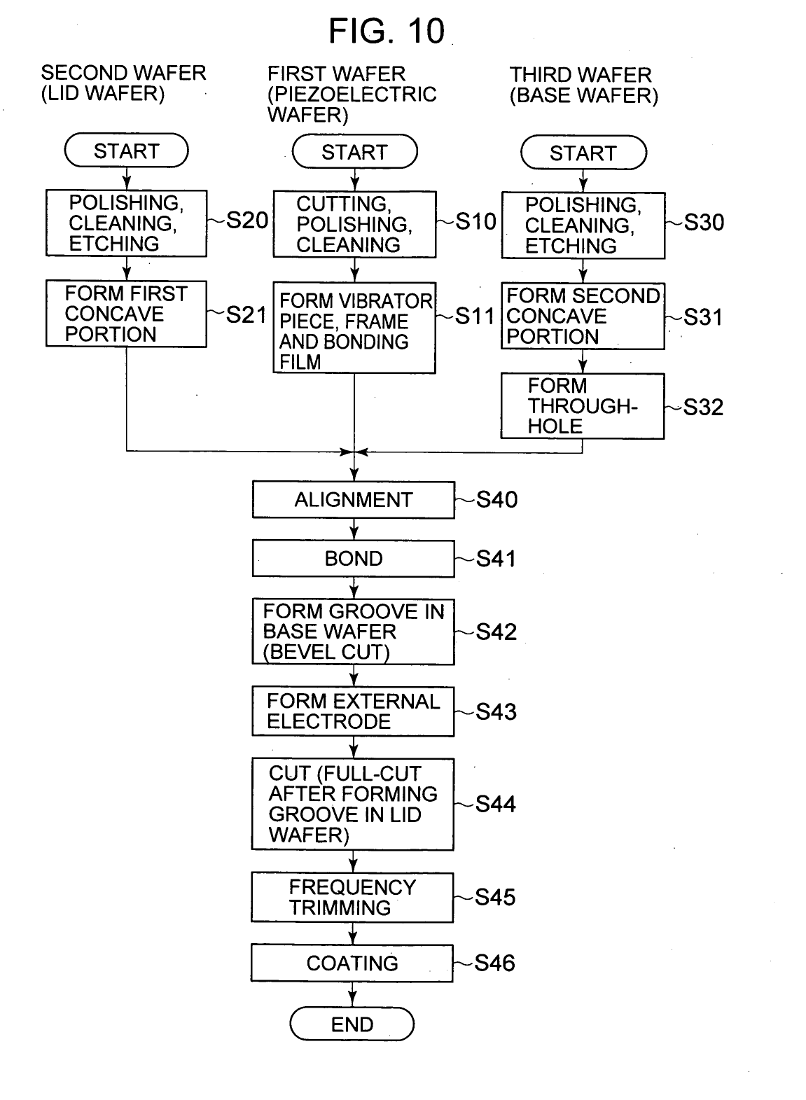

First, the basic manufacturing method will be described with reference to FIG. 10 which was used in “Related Art”. Furthermore, methods of manufacturing a lid wafer and a base wafer are the same as the methods described in the “Related Art” and thus their detailed description will be omitted.

In FIG. 10, a quartz crystal wafer which is a first wafer is formed by cutting a lumbered rude ore by a wire saw at a predetermined cut angle and lapping and polishing it. An affected layer of the surface thereof is removed and cleaned to form a wafer having a mirror surface (step 10).

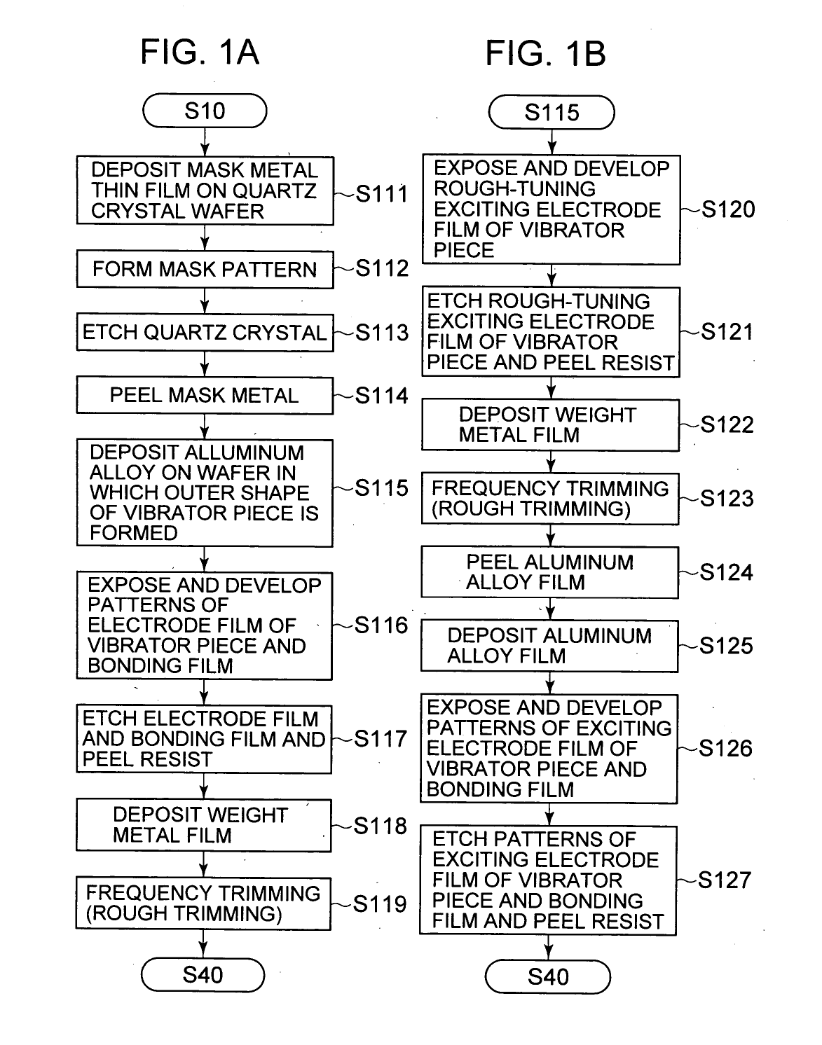

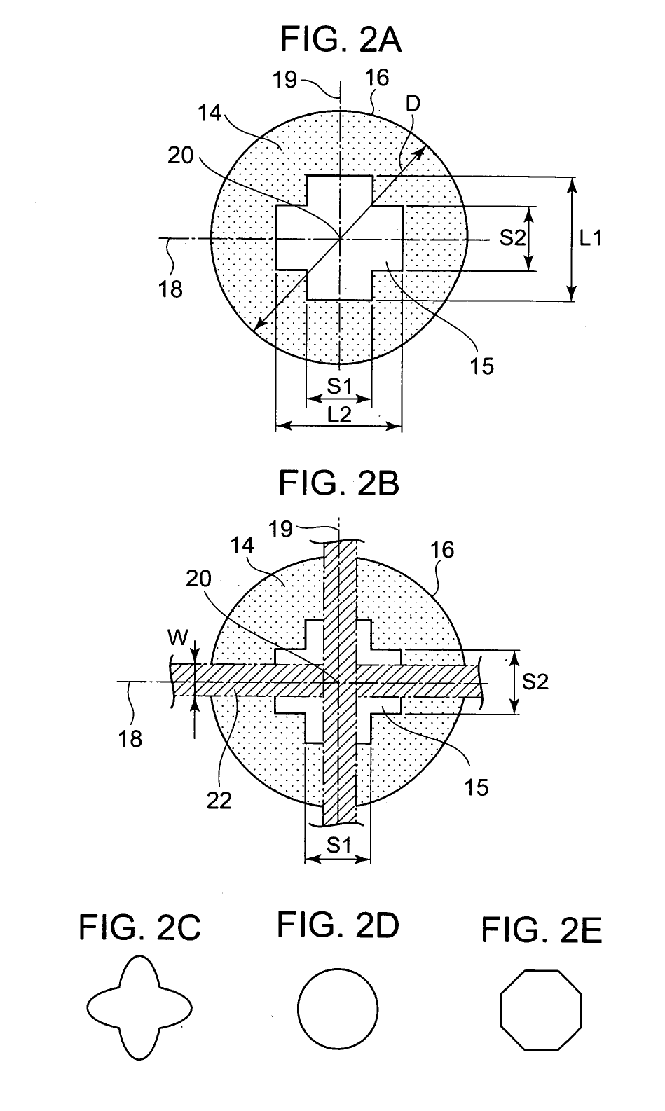

Next, step 11 of a process of forming a vibrator piece and a frame will be described with reference to FIGS. 1 and 2. FIG. 1 is a flowchart illustrating in detail a process of forming the vibrator piece and the frame in a method of manufacturing a piezoelectric vibrator according to the invention, where FIG. 1A illustrates a typical example (first embodiment) and FIG. 1B illustrates an example (second embodiment) in which a bonding film has improved bonding characteristics. FIG. 2 schematically illustrates a non-bonding film area in a portion of the bonding film formed in the method of manufacturing the piezoelectric vibrator according to the invention.

In FIG. 1A, a thin film, which is made of chromium and gold and becomes a mask, is deposited on a quartz crystal wafer by sputtering or the like (step 111). Next, an outer-shape mask pattern of a vibrator piece is formed by photolithography or the like in the thin film made of chromium and gold (step 112). Next, the quartz crystal is etched by a hydrofluoric acid solution to form the outer shape of the tuning fork type vibrator piece (step 113). Subsequently, the process progresses to a mask metal peeling step, in which the metal film of the mask is peeled (step 114). Next, an aluminum alloy thin film is deposited on the quartz crystal wafer on which the outer shape of the vibrator piece is formed (step 115). This thin film is used as an exciting electrode film of the vibrator piece and a bonding film on the frame. Furthermore, a pattern of the exciting electrode film and a pattern of the bonding film having the non-bonding film area are formed by photolithography on areas in which the vibrator piece and frame will be formed. In more detail, a resist film is formed and exposed and developed by a mask having the pattern of the exciting electrode of the vibrator piece and the pattern of the bonding film on the frame (step 116). Next, the aluminum alloy thin film is etched by etchant composed of acetic acid and phosphoric acid. After etching, the resist film is peeled. To this end, the pattern of the exciting electrode film is formed on the vibrator piece and the pattern of the bonding film having the non-bonding film area is formed in the vicinity of the vibrator piece to form the frame (step 117). Thereafter, a weight is deposited on the tuning fork type vibrator piece (step 118). Subsequently, rough trimming of a resonance frequency is performed (step 119).

FIG. 2A illustrates the pattern of one bonding film at four corners of one vibrator on the quartz crystal wafer formed as described above. FIG. 2B illustrates a cut area (shadow area) 22 cut by a cutting tool (dicing blade) on the pattern shown in FIG. 2A upon full-cut.

In FIGS. 2A and 2B, a circle 16 denotes a circle of the end of the bonding surface of the through-hole formed in the base wafer which will be bonded in the next step. In FIG. 2A, a cross-shaped area 15 is the non-bonding film area and, in FIG. 2B, the center of the cross-shaped area corresponds to an intersection 20 between the cut lines 18 and 19. The non-bonding film area is composed of two rectangles, one of which has a long side of L1 and a short side of S1 and the other of which has a long side of L2 and a short side S2. The two rectangles are symmetrical to each other with respect to the cut lines 18 and 19, respectively, the centers thereof are identical to each other, and the long sides thereof form an angle of 90 degrees. Although not shown, the rectangles have beveling portions at the respective corners thereof.

The lengths of the long sides L1 and L2 of the two rectangles are smaller than a diameter D of the circle 16 located at the end of the bonding surface of the through-hole. In addition, as shown in FIG. 2B, the lengths of the short sides S1 and S2 of the two rectangles are larger than a width W (substantially equal to the thickness T of the full-cut blade) of the full-cut locus.

An area 14 in the circle 16 located at the end of the bonding surface of the through-hole except the non-bonding film area has the bonding film. A lamination film made of chromium and gold is formed on the circle 16 located at the end of the bonding surface of the through-hole and the side surface of the through-hole by a vacuum deposition method or the sputtering as an external electrode. Since the external electrode is connected to the exciting electrode of the vibrator on the piezoelectric wafer, the area 14 having the bonding film has a small direct current resistance value as the area thereof is large and thus is suitable as the vibrator. Accordingly, the size of the non-bonding film area 15 is determined in consideration of the functions of reducing peeling of the film along the locus of the full-cut blade and suppressing the direct current resistance value of the vibrator.

The piezoelectric vibrator after cutting has, as described above, the length of the long side of 3.2 mm and the length of the short side of 1.2 mm, the diameter of the circle located at the end of the bonding surface of the through-hole of 450 μm and the width W of a portion cut by the full-cut dicing blade of 150 μm. In order to improve the yield of the wafer, the thickness of the full-cut dicing blade should be small. However, in the present work on which brittle materials are stuck, a dicing blade having a thickness of 150 μm was selected in consideration of rigidity and durability of the dicing blade. At this time, two rectangles forming the non-bonding film area 15 have the same size and the length of the long side L1 thereof was 300 μm and the length of the short side L2 thereof was 200 μm. By setting the length of the short side to 200 μm space of 25 μm is provided at one side of the cut width W (150 μm) of the full-cut dicing blade and thus an error of the cut position upon full-cut can be absorbed.

Here, it is preferable that the length of the long side L1 is set to be smaller than 400 μm. As described above, since the diameter of the circle located at the end of the bonding surface of the through-hole is 450 μm, the bonding film having at least 25 μm per one side and 50 μm in total is ensured for connecting the external electrode. Accordingly, the length of the long side of the rectangle of the non-bonding film area is set to be smaller than 400 μm.

In a case where the size of the outer shape of the piezoelectric vibrator is more minimized, the diameter of the circle 16 located at the end of the bonding surface of the through-hole is more reduced and thus the lengths of the long side L1 and the short side L2 of the rectangle are more reduced.

In the pattern shown in FIG. 2A, although the non-bonding film area 15 has the cross-shape in which two rectangles intersect by 90 degrees, the non-bonding film area 15 may have various shapes as shown in FIGS. 2C, 2D, and 2E. FIG. 2C illustrates a combination of ellipses, FIG. 2D illustrates a single shape such as a circle or an ellipse, and FIG. 2E illustrates a polygon in the single shape. Although not shown, the shape of the non-bonding film area 15 may be composed of a combination of barrel shapes or a combination of concave portions. Moreover, the shape of the non-bonding film area 15 may be composed of any one combination of different shapes such as a rectangle, an ellipse, a polygon, and a barrel shape, not a combination of the same shapes. Since the pattern of the non-bonding film area 15 can be easily formed by photolithography, when a photolithographic apparatus is already equipped and photolithography is performed, no significant change in process is required for embodying the invention and thus the manufacturing cost is hardly affected.

Next, a process of forming a vibrator piece and a frame in a method of manufacturing a piezoelectric vibrator according to a second embodiment of the invention will be described. FIG. 1B is a flowchart for more improving bonding characteristics in consideration of cleanliness of the surface of the bonding film, and is obtained by changing the steps 116 to 119 in the flowchart of FIG. 1A. The process after the step 116 will now be schematically described.

By the step 115, the rough-trimming exciting electrode film on the quartz crystal wafer on which the aluminum alloy film is deposited is exposed and developed (step 120). Subsequently, the aluminum alloy film is etched and the resist film is peeled (step 121). At this time, only the pattern of the rough-trimming exciting electrode film is formed on the vibrator piece and the pattern of the bonding film is not formed. Next, a weight metal film is deposited (step 122). Thereafter, the rough frequency trimming is performed (step 123).

In the frequency trimming step, since the weight metal film is evaporated by laser until the frequency becomes a predetermined range of the frequency, the evaporated metal component may be stuck, by a small amount, to a portion which becomes the bonding area. Accordingly, the bonding strength may be deteriorated. In order to avoid this problem, the aluminum alloy film including the exciting electrode film on the vibrator piece is peeled (step 124). Furthermore, an aluminum ally film is newly deposited under the same condition as that of the step 115 (step 125). The pattern of the exciting electrode film is formed on the vibrator piece by the newly deposited clean film and the pattern of the bonding film having the non-bonding film area is formed in the vicinity of the vibrator piece to form the frame. In more detail, a resist film is formed and then exposed and developed by a mask having the pattern of the exciting electrode on the vibrator piece and the pattern of the bonding film having the non-bonding film area on the frame (step 126). Next, the aluminum alloy thin film is etched. After etching, the resist film is peeled. To this end, the exciting electrode pattern is formed on the vibrator piece and the pattern of the bonding film having the non-bonding film area and the clean surface is formed in the vicinity of the vibrator piece to form the frame (step 127).

The manufacturing method will be described again with reference to FIG. 10. In the step 11, the quartz crystal wafer 4 on which the patterns of the electrode film on the vibrator piece and the bonding film is carried for an alignment process in which the quartz crystal wafer 4 is inserted between the lid wafer 5 and the base wafer 6 while aligned by an aligner (step 40).

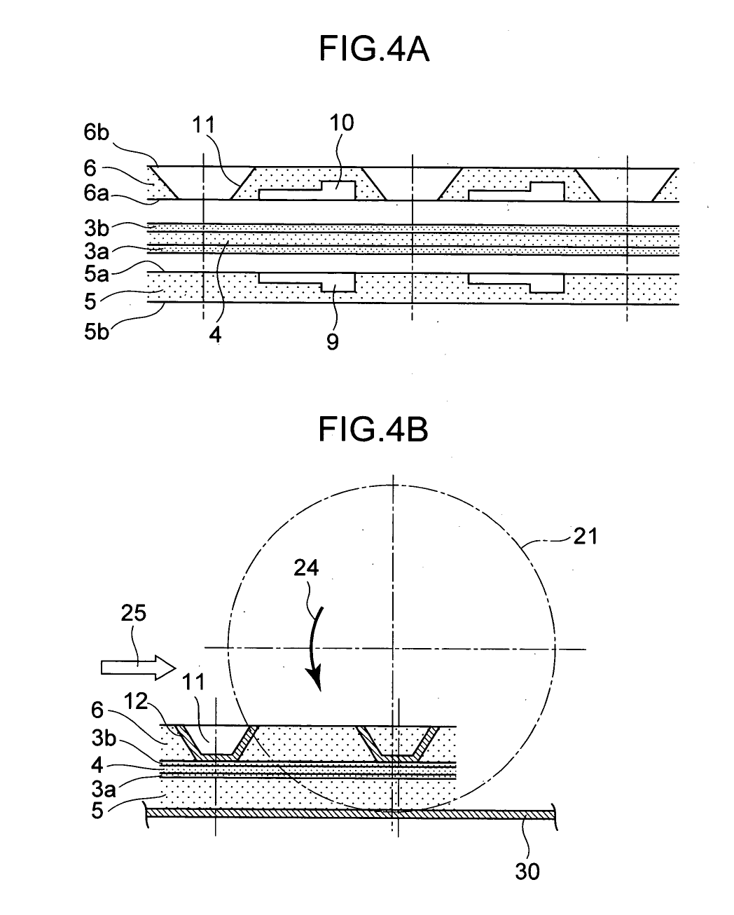

Here, the state of overlapping the three wafers is illustrated in FIG. 4A. On the basis of the quartz crystal wafer 4, the lid wafer 5 having first concave portions 9 and the base wafer 6 having second concave portions 10 and the through-holes 11 are aligned. The surface of the lid wafer 5 in which the first concave portions 9 are formed becomes the bonding surface 5a. Similarly, the surface of the base wafer 6 in which the second concave portions 10 are formed becomes the bonding surface 6a. The first concave portions 9 and the second concave portions 10 face each other and are aligned such that mechanical deformation due to vibration of the vibrator is not prevented.

The three overlapped wafers are placed in an anodic bonding jig to be anodic-bonded. In the anodic bonding, a predetermined bonding temperature and an applied voltage are maintained and the temperature of a bonding apparatus gradually decreased after detecting an end point of the bonding and then returned to a normal temperature (step 41). By this process, the vibrator piece is hermetically sealed in the upper and lower glasses and the frame. In the anodic bonding state, V-shaped grooves are formed in the non-bonding surface 6b of the base wafer by a dicing saw or the like at positions corresponding to a predetermined size of the piezoelectric vibrator and intervals (pitch of the long side direction is P1 and pitch of the short side direction is P2) (step 42). Subsequently, a metal mask is placed on the non-bonding surface 6b of the base wafer and a layered pattern of the metal thin film forming the external electrode film 12 (see FIG. 12) is formed by a sputtering or deposition method (step 43). At this time, the external electrode film 12 is deposited on the side surface of the through-hole 11 (see FIG. 12) and the entire area in the circle 16 located at the end of the bonding surface of the through-hole shown in FIG. 2A. That is, the external electrode film 12 is also deposited on the non-bonding film area.

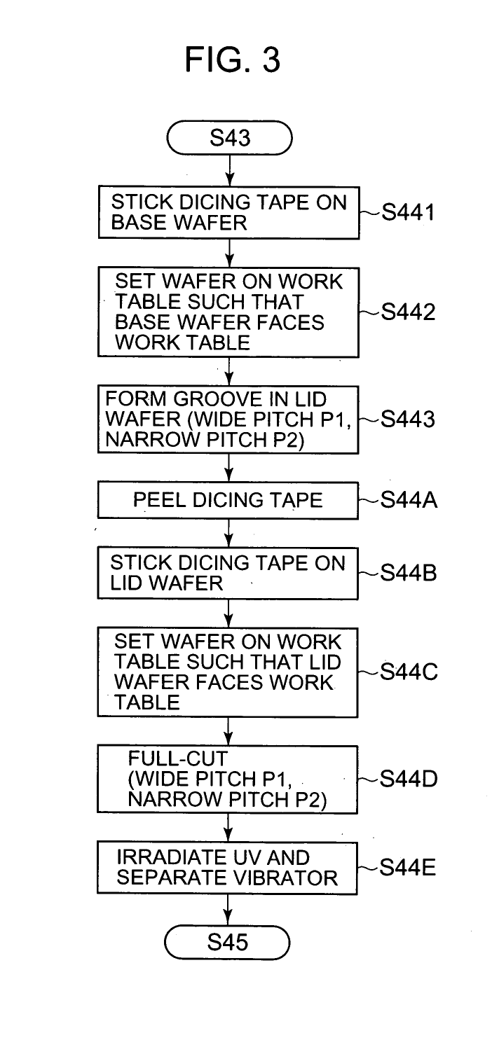

The cut process of the step 44 will be described with reference to the flowchart illustrating the full-cut process according to the invention shown in FIG. 3 and the full-cut process according to the invention shown in FIG. 4B.

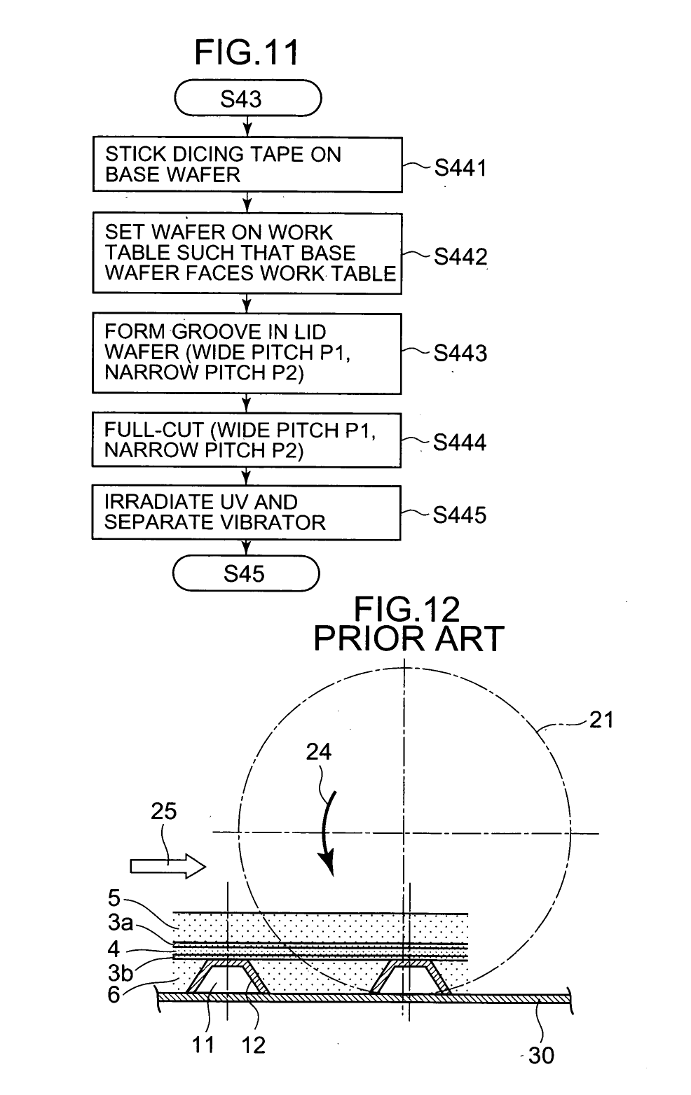

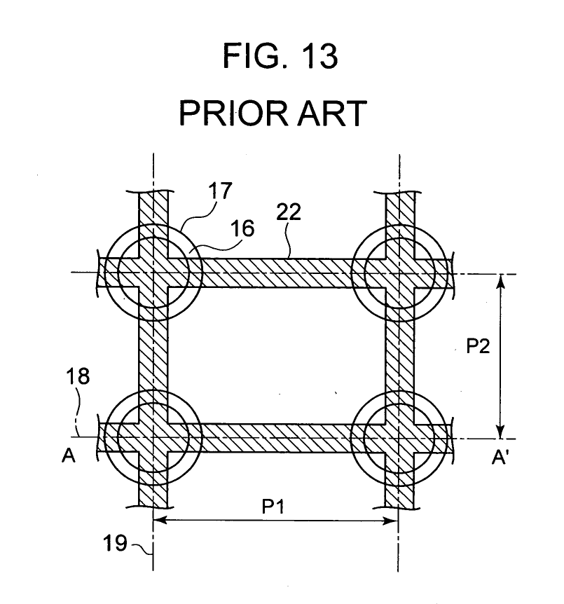

In FIG. 3, the external electrode film is formed in the step 43 and the dicing tape 30 is then stuck to the non-bonding surface 6b of the base wafer 6 (step 441). The wafer is mounted on the work table of the dicing saw (not shown) such that the lid wafer 5 faces upward (step 442). V-shaped grooves are formed in the non-bonding surface 5b of the lid wafer 5 (step 443). The V-shaped grooves are formed in the positions corresponding to the grooves of the base wafer 6 at the pitches P1 and P2 equal to the grooves of the base wafer 6 formed in the step 42. In this step, the V-shaped grooves which are formed in the non-bonding surfaces 5b and 6b of the lid wafer 5 and the base wafer 6 face each other. The aforementioned steps are similar to the cut process described with reference to FIG. 11 in “Related Art”, however the following processes are reviewed in the invention.

In the cut process of the invention, subsequently, the dicing tape stuck to the base wafer 6 is peeled (step 44A). Next, the dicing tape is stuck to the non-bonding surface 5b of the lid wafer 5 (step 44B). Subsequently, the wafer is mounted on the work table of the dicing saw (now shown) such that the base wafer 6 faces upward (step 44C).

FIG. 4B illustrates the full-cut process according to the invention and illustrates the cut surface of the wafer and the state during cutting after the step 44C. In FIG. 4B, the first concave portions 9 and the second concave portions 10 are omitted. In FIG. 4B, the thickness T of the full-cut dicing blade 21 shown by an imaginary line is 150 μm and a predetermined rotation direction and rotation number are set. The dicing blade 21 is fixed in an XY direction (plane direction of the wafer) and the work table is moved on the plane at a predetermined speed. An arrow 25 represents a movement direction of the work table. In Figure, the wafer is moved from the left side to the right side. The cut depth of the full-cut dicing blade 21 (Z-direction: a direction perpendicular to the plane of the wafer) is set to the extent of leaving the locus in the surface of the dicing tape 30 (about 5 μm) and the table is carried several times in the long side direction and the short side direction such that the wafer is divided into respective piezoelectric vibrators (step 44D).

In the portion except the through-hole 11 of the wafer upon the cut process, the bonding films 3a and 3b are bonded between the quartz crystal wafer 4 and the lid wafer 5 and between the quartz crystal wafer 4 and the base wafer 6, and are subjected to a rigid mechanical constraint by the lid wafer 5 and the base wafer 6. Accordingly, the bonding films 3a and 3b are hardly peeled by the rotation direction 24 of the full-cut dicing blade 21.

In the end of the bonding surface of the through-hole, the area 14 of the base wafer having the bonding film shown FIG. 2A is covered with only the external electrode film 12 made of chromium and gold and has a weak mechanical constraint. However, since a shearing force generated by the rotation direction 24 of the full-cut dicing blade 21 is applied in a direction of pressing the bonding film 3b, it cannot peel the bonding film 3b and the external electrode film 12 covering the bonding film 3b from the quartz crystal wafer 4. That is, if the wafer is cut using a cutting tool such as a blade, it is preferable that the wafer should be cut such that the shearing force of the cutting tool is applied from the wafer in which the through-hole is formed to the wafer in which the through-hole is not formed.

However, in the conventional cut process, as described in “Related art”, the wafer is mounted on the work table such that the base wafer 6 in which the through-hole 11 is formed faces the work table, as shown in FIG. 12. If the non-bonding film area is formed in the end of the bonding surface of the through-hole 11, the bonding film 3b is not peeled at the corresponding portion. However, upon cutting the area 14 (see FIG. 2A) having the bonding film 3b in the end of the bonding surface of the through-hole 11, the direction of applying the shearing force by the rotation direction 24 of the full-cut dicing blade 21 is identical to a direction of peeling the external electrode film 12 made of chromium and gold, and thus the bonding film 3b may be peeled.

Although, in the present embodiment, the film is prevented from being peeled by mounting the wafer such that the base wafer 6 faces upward, the wafer may be mounted such that the base wafer 6 faces the work table. For example, the wafer may be cut at the upper side of the full-cut dicing blade 21 by sticking the dicing tape 30 to the lid wafer 5 and placing the rotation shaft of the full-cut dicing blade 21 below the wafer. In addition, various apparatuses for cutting the wafer may be used. It is preferable that the shearing force of the cutting tool is applied from the wafer in which the through-hole is formed to the wafer in which the through-hole is not formed.

Referring back to FIG. 3, after the cut process, the vibrator is ejected from the table with the dicing tape 30 being stuck thereto, is irradiated with ultraviolet rays, and then separated from the dicing tape 30 (step 44E).

Thereafter, the vibrator individually cut is aligned and then carried to the next process. However, the following frequency trimming process (step 45) and the corrosion resist film coating process (step 46) are the same as those described in “Related Art” and thus their description will be omitted.

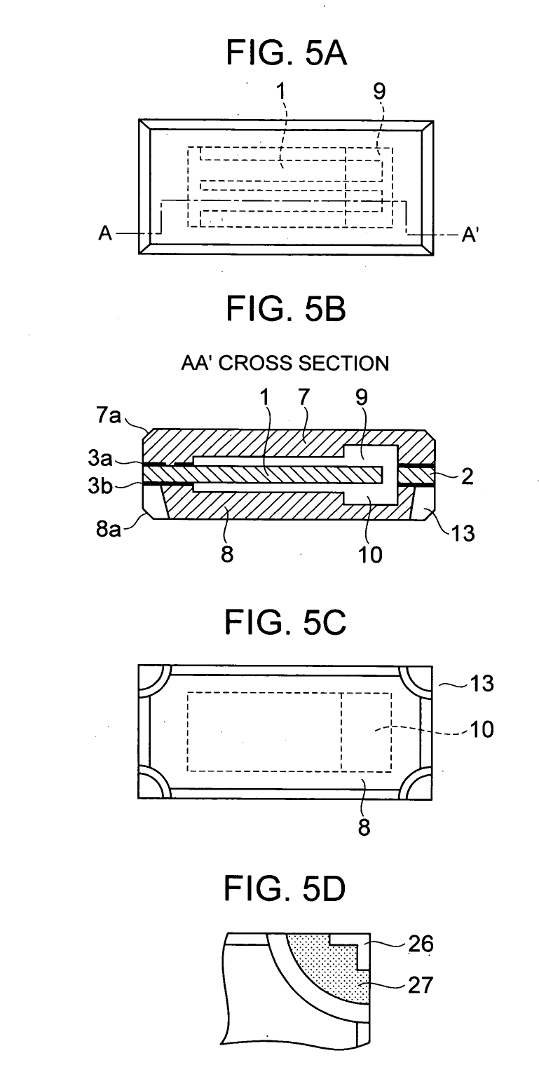

Next, the piezoelectric vibrator manufactured by the manufacturing method will be described with reference to the accompanying drawings. FIG. 5 illustrates an example of the tuning fork type piezoelectric vibrator according to the invention. Here, the corrosion resist film is omitted. FIG. 5A is a plan view illustrating the lid, in which the vibrator piece and the concave portion formed in the bonding surface are indicated by dotted lines. FIG. 5B is a front view illustrating AA′ cross section.

As shown in FIG. 5, the tuning fork type piezoelectric vibrator is stuck with the lid 7 and the base 8 by the bonding film 3a and 3b formed on the front and rear surfaces of the frame 2. The space formed by the first concave portion 9 and the second concave portion 10 which are formed in the lid 7 and the base 8, respectively, is hermetically sealed with vacuum and the vibrator piece 1 mechanically oscillates in this space with a predetermined oscillation number. The beveling portions 7a and 8a are formed in four edges of the lid 7 and four edges of the base 8, respectively, and have an outer shape which is strong in crack due to impact. FIG. 5C is a bottom view illustrating the base 8. The external connecting portions 13 for connecting, for example, an oscillation circuit are provided in four corners of the base 8 and the upper and lower pairs of external connecting portions 13 have the same polarity. The external electrode film is not shown in figures. FIG. 5D is a partial enlarged view illustrating one of the external connecting portions (the external electrode film is not shown). The non-bonding film area of the invention is quartered in the full-cut process. The quarter of the non-bonding film area in which the rectangles are combined in a perpendicular direction is denoted by reference numeral 26. In addition, the bonding film area in the through-hole is quartered. The quarter of the bonding film area is denoted by reference numeral 27.

Table 2 is an environment test result of the sample of the piezoelectric vibrator manufactured by the manufacturing method according to the invention. This sample is manufactured by cutting the wafer such that the shearing force is applied from the wafer in which the through-hole is formed to the wafer in which the through-hole is not formed when the non-bonding film area smaller than the end of the bonding surface of the through-hole is formed in a portion of the bonding film aligned with the bottom of the through-hole of the base wafer.

TABLE 2
Failure occurrence rate in environment resistance test of the piezoelectric
vibrator according to the manufacturing method according to the invention

| | Test name | | |
|---|---|---|---|
| | Pressure cooker | Constant temperature | Constant temperature |
| | Test | and humidity test 1 | and humidity test 2 |
| | Temperature and humidity | | |
| | Temperature: 121° C. | Temperature: 60° C. | Temperature: 85° C. |
| | Humidity: 100% | Humidity: 95% | Humidity: 85% |
| | Test duration | | |
| Lot | 24 hours | 2000 hours | 2000 hours |
| Lot 1 (n = 30) | 0% | 0% | 0% |
| Lot 2 (n = 30) | 0% | 0% | 0% |
| Lot 3 (n = 30) | 0% | 0% | 0% |
| Lot 4 (n = 30) | 0% | 0% | 0% |
| Lot 5 (n = 30) | 0% | 0% | 0% |

In the pressure cooker test (temperature: 121° C., humidity: 100%, test duration: 24 hours), the degradation of the sample which is left in the ambient atmosphere of two pressures is observed. The constant temperature and humidity test 1 (temperature: 60° C., humidity: 95%, test duration: 2000 hours) is the humidity test required for civilian goods such as a personal digital assistant. Furthermore, the constant temperature and humidity test 2 (temperature: 85° C., humidity: 85%, testing time: 2000 hours) is the humidity test which is applied in a severe environment such as vehicle installation. These constant temperature tests are generally performed during the testing time of 1000 hours, but are performed during 2000 hours in the present tests. The number of the test samples in each lot is 30.

In the test sample of the piezoelectric vibrator according the manufacturing method of the invention, the successive five lots do not have failure in the constant temperature and humidity test 2 as well as in the pressure cooker test and the constant temperature and humidity test 1. As such, the variation of the resonance frequency and the resonance resistance value are suppressed even in the severe environment.

As described in “Related Art”, in the sample according to the conventional manufacturing method, the lot 1 has two failures and the lot 2 has one failure in the constant temperature and humidity test 2, as shown in Table 1. Accordingly, from the comparison between the test results of Table 1 and Table 2, it can be seen that a piezoelectric vibrator having excellent environment resistance performance is obtained according the invention.

The test result of Table 2 is obtained by using the sample in which the non-bonding film area is provided in a portion of the bonding film and which is cut such that the shearing force is applied from the wafer in which the through-hole is formed to the wafer in which the through-hole is not formed. The environment resistance performance can be improved even in two inventions are separately embodied. If the both inventions are embodied, larger effect can be obtained.

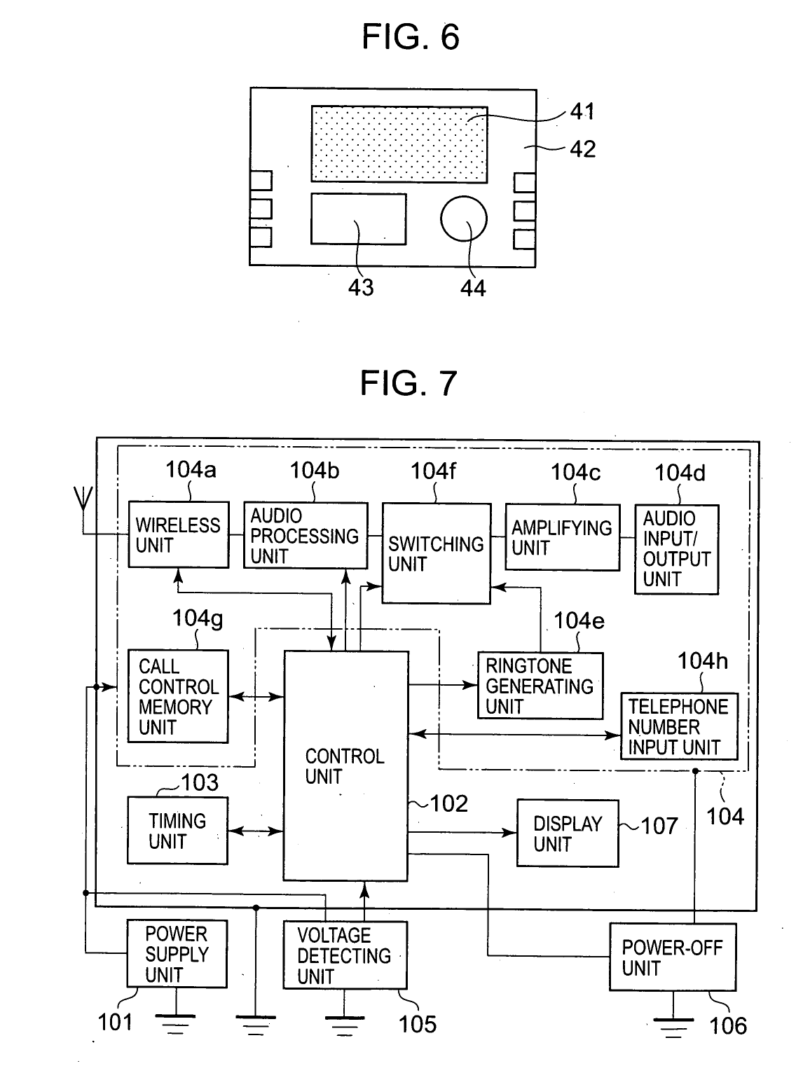

FIG. 6 is a schematic view illustrating a construction of a tuning fork type quartz oscillator according to a third embodiment of the invention, and is a plan view of a surface mount type piezoelectric vibrator using the tuning fork type quartz crystal vibrator.

In FIG. 6, a tuning fork type quartz crystal vibrator 41 is disposed at a predetermined position of a substrate 42 and an integrated circuit 43 for an oscillator is disposed adjacent to the quartz crystal vibrator. In addition, an electronic part 44 such as a capacitor is mounted. These elements are electrically connected to one another through wiring patterns (not shown). The mechanical vibration of the vibrator piece of the tuning fork type quartz crystal vibrator 41 is converted into an electrical signal by piezoelectric characteristics of the quartz crystal and input to the integrated circuit 43. The integrated circuit 43 functions as an oscillator for processing a signal and outputs a frequency signal. These elements are molded with resin (not shown). By selecting, for example, an RTC (real time clock) module as the integrated circuit 43, it is possible to control the operation date and time of a corresponding apparatus or an external apparatus as well as a dedicated oscillator for clock or provide time or calendar information to a user.

By constructing the oscillator by the piezoelectric vibrator manufactured by the manufacturing method according to the invention, even when the oscillator is used in an environment of high temperature and humidity for a long time, it is difficult to change the characteristics of the piezoelectric vibrator and thus the oscillator can be maintain with high precision.

FIG. 7 is a schematic block diagram of an electronic apparatus according to a fourth embodiment of the invention. The electronic apparatus is a wristwatch type communication apparatus having a watch function and a communication function, which has the substantially same appearance as that of a wristwatch and is more miniaturized and lightweight compared with a conventional portable telephone.

In FIG. 7, reference numeral 101 denotes a power supply unit for supplying power to each function unit described later, which is realized, for example, by a lithium ion secondary battery. The power supply unit 101 is connected to a control unit 102, a timing unit 103, a communication unit 104, a voltage detecting unit 105, and a display unit 107 in parallel and supplies power to each function unit.

The control unit 102 controls each function unit to control the entire operations of the system such as transmission/reception of voice data and measurement or display of current time. The control unit 102 is realized by a program which is already recorded in a ROM, a CPU for reading and executing the corresponding program, and a RAM used as a work area of the corresponding CPU.

The timing unit 103 is composed of an integrated circuit in which an oscillation circuit, a register circuit, a counter circuit and an interface circuit, and a tuning fork type quartz crystal vibrator shown in FIG. 5. The mechanical vibration of the tuning fork type quartz crystal vibrator is converted into an electrical signal by the piezoelectric characteristics of the quartz crystal and input to the oscillation circuit composed of a transistor and a capacitor. The output of the oscillation circuit is binarized and counted by the register circuit and the counter circuit. The signal transmission/reception with the control unit is performed through the interface circuit and current time, current date, or calendar information is displayed on the display unit 107.

The communication unit 104 has the same function as that of the conventional portable telephone and is composed of a wireless unit 104a, an audio processing unit 104b, an amplifying unit 104c, an audio input/output unit 104d, a ringtone generating unit 104e, a switch unit 104f, a call control memory unit 104g, and a telephone number input unit 104h.

The wireless unit 104a transmits/receives various data such as audio data to/from a base station through an antenna. The audio processing unit 104b encodes/decodes the audio signal input from the wireless unit 104a or the amplifying unit 104c described later. The amplifying unit 104c amplifies the signal input from the audio processing unit 104b or the audio input/output unit 104d which will be described later to a predetermined level. The audio input/output unit 104d is a speaker and a microphone and amplifies a ringtone or a received voice or collects a speaker's voice.

Furthermore, the ringtone generating unit 104e generates a ringtone in response to the call of the base station. The switch unit 104f connects the amplifying unit 104c connected to the audio processing unit 104b to the ringtone generating unit 104e only when the call is received, to output the generated ringtone to the audio input/output unit 104d through the amplifying unit 104c.

Moreover, the call control memory unit 104g stores a program related to the call control in the communication. In addition, the telephone number input unit 104h is composed of number keys 0 to 9 and other keys and used in inputting the telephone number of a destination to be communicated.

The voltage detecting unit 105 detects a voltage drop and notifies it to the control unit 102 when the voltage which is applied to each function unit including the control unit 102 by the power supply unit 101 is less than a predetermined value. This predetermined voltage value is already set as a lowest value required for stably operating the communication unit 104, for example, about 3 V. The control unit 102, which receives the voltage drop from the voltage detecting unit 105, prohibits the wireless unit 104a, the audio processing unit 104b, the switch unit 104f, the ringtone generating unit 104e from operating. Particularly, it is necessary to prohibit the wireless unit 104a having large power consumption from operating. In addition, the state that the communication unit 104 cannot be used due to lack of battery power is displayed on the display unit 107.

The operation of the communication unit 104 is prohibited by operating the voltage detecting unit 105 and the control unit 102 and the state that the communication unit cannot be used can be displayed on the display unit 107.

In the present embodiment, by providing a power-off unit 106 for selectively blocking the power applied to the portion related to the function of the communication unit, the function of the communication unit more perfectly stops.

In addition, the state that the communication unit 104 cannot be used may be displayed by a message or, more intuitively, a mark (x) displayed at a telephone icon on the display unit 107.

By using the piezoelectric vibrator manufactured by the manufacturing method of the invention in an electronic apparatus, even when the electronic apparatus is used in a severe environment of a high temperature and high humidity for a long time, it is difficult to change the characteristics of the piezoelectric vibrator and thus the electronic apparatus can be maintained with high precision.

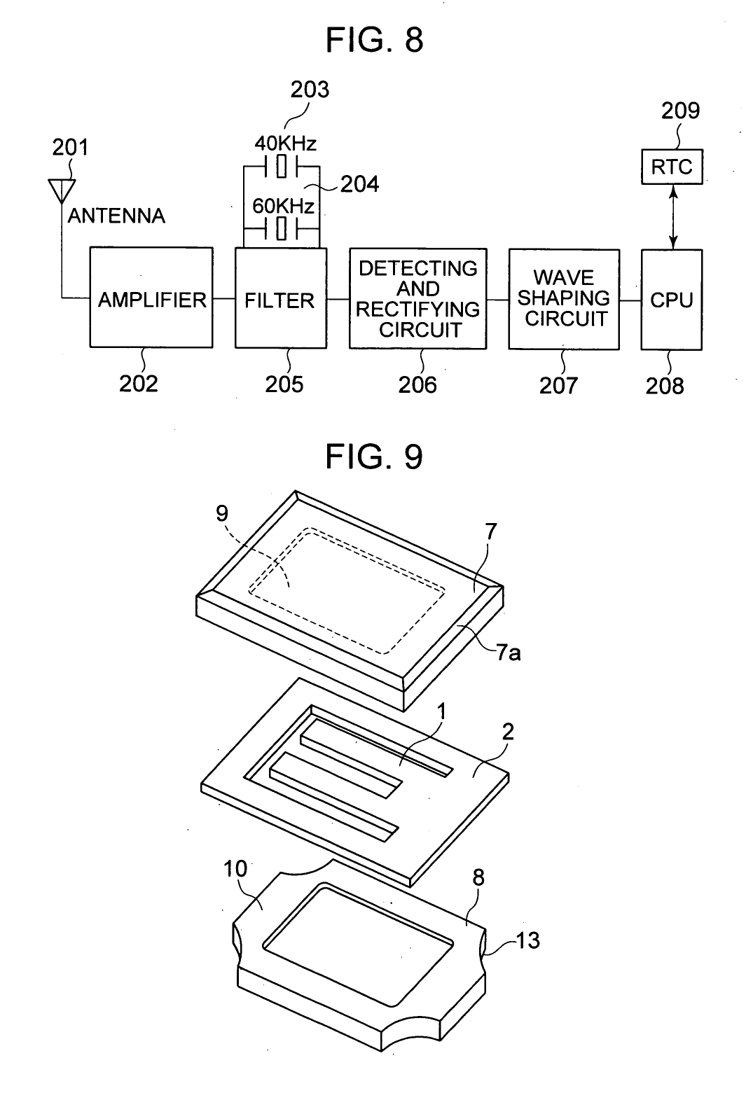

FIG. 8 is a schematic circuit block diagram of a wave clock as an electronic apparatus according to a fifth embodiment of the invention. Here, the tuning fork type quartz crystal vibrator (piezoelectric vibrator) manufactured by the manufacturing method of the invention is used in a filter unit of the wave clock.

The wave clock includes a function which receives standard wave including time information and automatically corrects and displays it. In Fukushimaken (40 KHz) and Sagaken (60 KHz) of Japan, there are transmission stations for transmitting the standard wave. The long wave such as 40 KHz or 60 KHz has a property that it propagates through earth's surface and a property that it propagates through an ionized layer and earth's surface while being reflected therefrom and thus has a wide wave range. Thus, two transmission stations cover the entire range in Japan.

In FIG. 8, an antenna 201 receives the long standard wave of 40 KHz or 60 KHz. The long standard wave is obtained by AM-modulating the time information called as a time code to a carrier of 40 KHz or 60 KHz.

The received long standard wave is amplified by an amplifier 202 and filtered and tuned by a filter unit 205 including quartz crystal vibrators 203 and 204 having the same resonance frequency as the carrier frequency. The filtered signal of a predetermined frequency is detected and demodulated by a detecting and rectifying circuit 206. Subsequently, the time code is extracted by a wave shaping circuit 207 and counted by a CPU 208. In the CPU 208, current year, accumulated date, a day of the week and time are read. The read information is applied to an RTC 209 and thus accurate time information is displayed.

Since the carrier has 40 KHz or 60 KHz, the quartz crystal vibrators 203 and 204 composing the filter unit is preferably tuning fork type vibrators. In the case of 60 KHz, the total length of the tuning fork type vibrator piece may be about 2.8 mm and the width of the base may be about 0.5 mm.

Since the piezoelectric vibrator manufactured by the manufacturing method of the invention is used in the electronic apparatus, and, particularly, in the filter unit of the wave clock, even when the wave clock is used in a severe environment for a long time, it is difficult to change the characteristics of the piezoelectric vibrator. Accordingly, the filter function of the wave clock can be maintained and moved with high precision for a long time.

What is claimed is:

1. A manufacturing method of a piezoelectric vibrator comprising:
forming integrally a vibrator piece and a frame surrounding the vibrator piece on a first wafer and forming bonding films on the both surfaces of the frame;
forming a through-hole at a position corresponding to the frame of the first wafer in any one of a second wafer and a third wafer;
sticking the second wafer and the third wafer on the both surfaces of the first wafer, respectively; and
cutting the stuck three wafers at a predetermined position,
wherein the forming of the vibrator piece and the frame includes forming a non-bonding film area smaller than the through-hole at a position corresponding to the through-hole of the bonding film, and
the cutting of the wafers includes cutting the wafers such that the non-bonding film area is divided.

2. A manufacturing method of a piezoelectric vibrator according to claim 1, wherein, when forming the non-bonding film area, the center of the non-bonding film area is approximately placed in the vicinity of the intersection between a cut line of a long side direction and a cut line of a short side direction, which divide the piezoelectric vibrator, and the shape of the non-bonding film area is approximately symmetrical with respect to each of the two cut lines intersected.

3. A manufacturing method of a piezoelectric vibrator according to claim 1, wherein, when forming the non-bonding film area, the shape of the non-bonding film area is composed of a combination of two rectangles and the centers of the two rectangles are identical to each other such that the respective long sides thereof form an angle of about 90 degrees.

4. A manufacturing method of a piezoelectric vibrator according to claim 3, wherein, when forming the non-bonding film area, the sizes of the long sides of the two rectangles are smaller than the diameter of the bottom of the through-hole and the sizes of the short sides of the two rectangles are larger than the thickness of a cutting tool used in the cutting of the wafers.

5. A manufacturing method of a piezoelectric vibrator according to claim 4, wherein, when forming the non-bonding film area, the sizes of the long sides of the two rectangles are smaller than about 400 μm and the sizes of the short sides of the two rectangles are larger than about 150 μm.

6. A manufacturing method of a piezoelectric vibrator comprising:
forming integrally a vibrator piece and a frame surrounding the vibrator piece on a first wafer and forming bonding films on the both surfaces of the frame;
forming a through-hole at a position corresponding to the frame of the first wafer in any one of a second wafer and a third wafer;
sticking the second wafer and the third wafer on the both surfaces of the first wafer, respectively; and
cutting the stuck three wafers at a predetermined position,
wherein the cutting of the wafers includes cutting the wafers such that a shearing force of a cutting tool for cutting the three wafers is applied from the wafer in which the through-hole is formed to the wafer in which the through-hole is not formed.

7. A manufacturing method of a piezoelectric vibrator comprising:
forming integrally a vibrator piece and a frame surrounding the vibrator piece on a first wafer and forming bonding films on the both surfaces of the frame;
forming a through-hole at a position corresponding to the frame of the first wafer in any one of a second wafer and a third wafer;
sticking the second wafer and the third wafer on the both surfaces of the first wafer, respectively; and
cutting the stuck three wafers at a predetermined position,
wherein the forming of the vibrator piece and the frame includes forming a non-bonding film area smaller than the through-hole at a position corresponding to the through-hole of the bonding film, and
the cutting of the wafers includes cutting the wafers such that the non-bonding film area is divided and a shearing force of a cutting tool for cutting the three wafers is applied from the wafer in which the through-hole is formed to the wafer in which the through-hole is not formed.

8. A manufacturing method of a piezoelectric vibrator according to claim 7, wherein, when forming the non-bonding film area, the center of the non-bonding film area is approximately placed in the vicinity of the intersection between a cut line of a long side direction and a cut line of a short side direction, which divide the piezoelectric vibrator, and the shape of the non-bonding film area is approximately symmetrical with respect to each of the two cut lines intersected.

9. A manufacturing method of a piezoelectric vibrator according to claim 7, wherein, when forming the non-bonding film area, the shape of the non-bonding film area is composed of a combination of two rectangles and the centers of the two rectangles are identical to each other such that the respective long sides thereof form an angle of about 90 degrees.

10. A manufacturing method of a piezoelectric vibrator according to claim 9, wherein, when forming the non-bonding film area, the sizes of the long sides of the two rectangles are smaller than the diameter of the bottom of the through-hole and the sizes of the short sides of the two rectangles are larger than the thickness of a cutting tool used in the cutting of the wafer.

11. A manufacturing method of a piezoelectric vibrator according to claim 10, wherein, when forming the non-bonding film area, the sizes of the long sides of the two rectangles are smaller than about 400 μm and the sizes of the short sides of the two rectangles are larger than about 150 μm.

12. A piezoelectric vibrator manufactured by the manufacturing method of a piezoelectric vibrator according to claim 1.

13. A piezoelectric vibrator manufactured by the manufacturing method of a piezoelectric vibrator according to claim 6.

14. A piezoelectric vibrator manufactured by the manufacturing method of a piezoelectric vibrator according to claim 7.

15. A piezoelectric vibrator comprising:
a vibrator piece;
a frame which is connected to one end of the vibrator piece and integrally formed to surround the vibrator piece;
a lid which is stuck to the frame through a first bonding film and has a concave portion at a position facing the vibrator piece; and
a base which is stuck to the frame through a second bonding film at the opposite to the lid and has a concave portion at a position facing the vibrator piece and in which an external electrode is provided at the corner thereof,
wherein a non-bonding film area is formed at a portion which contacts the external electrode of the second bonding film.

16. An oscillator in which a piezoelectric vibrator is connected as an oscillator to an integrated circuit, wherein the piezoelectric vibrator comprises:
a vibrator piece;
a frame which is connected to one end of the vibrator piece and integrally formed to surround the vibrator piece;
a lid which is stuck to the frame through a first bonding film and has a concave portion at a position facing the vibrator piece; and
a base which is stuck to the frame through a second bonding film at the opposite side of the lid and has a concave portion at a position facing the vibrator piece and in which an external electrode is provided at the corner thereof,
wherein a non-bonding film area is formed at a portion which contacts the external electrode of the second bonding film.

17. An electronic apparatus in which a piezoelectric vibrator is connected to a timing unit, wherein the piezoelectric vibrator comprises:
a vibrator piece;
a frame which is connected to one end of the vibrator piece and integrally formed to surround the vibrator piece;
a lid which is stuck to the frame through a first bonding film and has a concave portion at a position facing the vibrator piece; and
a base which is stuck to the frame through a second bonding film at the opposite to the lid and has a concave portion at a position facing the vibrator piece and in which an external electrode is provided at the corner thereof,
wherein a non-bonding film area is formed at a portion which contacts the external electrode of the second bonding film.

18. A wave clock in which a piezoelectric vibrator is connected to a filter unit, wherein the piezoelectric vibrator comprises:
a vibrator piece;
a frame which is connected to one end of the vibrator piece and integrally formed to surround the vibrator piece;
a lid which is stuck to the frame through a first bonding film and has a concave portion at a position facing the vibrator piece; and
a base which is stuck to the frame through a second bonding film at the opposite side of the lid and has a concave portion at a position facing the vibrator piece and in which an external electrode is provided at the corner thereof,
wherein a non-bonding film area is formed at a portion which contacts the external electrode of the second bonding film.
